(19) United States
(12) Patent Application Publication
(10) Pub. No.: US 2025/0364894 A1
(43) Pub. Date: Nov. 27, 2025

(54) DC-DC BOOST CIRCUIT AND DRIVING CIRCUIT BOARD

(71) Applicants: Beijing BOE Display Technology Co., Ltd., Beijing (CN); BOE TECHNOLOGY GROUP CO., LTD., Beijing (CN)

(72) Inventors: Jianting WANG, Beijing (CN); Zhengyan WAN, Beijing (CN)

(73) Assignees: Beijing BOE Display Technology Co., Ltd., Beijing (CN); BOE TECHNOLOGY GROUP CO., LTD., Beijing (CN)

(21) Appl. No.: 19/099,320

(22) PCT Filed: Apr. 23, 2024
(86) PCT No.: PCT/CN2024/089239

§ 371 Date: Jan. 28, 2025

(30) Foreign Application Priority Data
May 31, 2023 (CN) 202310632831.X

(51) Int. Cl. H02M 1/08; G09G 3/32; H02M 1/14; H02M 3/08; H02M 3/145

(52) U.S. Cl. CPC H02M 1/08; G09G 3/32; H02M 1/14; H02M 3/08; H02M 3/145

(57) ABSTRACT

The present disclosure belongs to the technical field of display. Provided are a DC-DC boost circuit and a driving circuit board. The DC-DC boost circuit includes a power MOSFET, and a control circuit electrically connected to a control terminal of the power MOSFET and configured to provide a control signal capable of controlling turn-on and turn-off of the power MOSFET. A voltage value of a high-level signal in the control signal is 0.5 to 0.8 times a maximum rated value of a gate-source voltage of the power MOSFET.

### CROSS-REFERENCE TO RELATED APPLICATIONS

This disclosure is the U.S. National phase application of International Application No. PCT/CN2024/089239, filed on Apr. 23, 2024, which claims priority to a Chinese patent application No. 202310632831.X, filed on May 31, 2023, and entitled “DC-DC BOOST CIRCUIT AND DRIVING CIRCUIT BOARD,” the entire contents of both of which are incorporated herein by reference in their entireties.

### TECHNICAL FIELD

This disclosure relates to the field of display technologies, and in particular, to a DC-DC boost circuit and a driving circuit board.

### BACKGROUND

In display devices such as high-brightness liquid crystal displays and micro-light-emitting diode displays, Direct Current to Direct Current (DC-DC) boost circuits with relatively high power are often used. Limited by factors such as size and cost, these DC-DC boost circuits often adopt power Metal-Oxide-Semiconductor Field-Effect Transistors (MOSFETs) with small packages, and often cannot accommodate the addition of heat sinks. This results in MOSFETs facing problems of excessive temperature.

It should be noted that the information disclosed above in the “BACKGROUND” section is only used to enhance the understanding of the background of this disclosure, and thus may include information that does not constitute prior art known to those of ordinary skill in the art.

### SUMMARY

The objective of this disclosure is to overcome the deficiencies of the prior art mentioned above, and to provide a DC-DC boost circuit and a driving circuit board to reduce the temperature of the power MOSFET.

According to an aspect of this disclosure, a DC-DC boost circuit is provided, including a power MOSFET and a control module electrically connected to a control terminal of the power MOSFET. The control module is configured to provide a control signal capable of controlling turn-on and turn-off of the power MOSFET, wherein a voltage value of a high-level signal in the control signal is 0.5 to 0.8 times a maximum rated value of a gate-source voltage of the power MOSFET.

According to an embodiment of this disclosure, the control module is further configured such that when providing a sink current to the control terminal of the power MOSFET, a maximum value of the sink current is not less than 0.5A.

According to an embodiment of this disclosure, the control module includes a driver chip, a voltage regulation unit, an inverting unit, and a driving unit. The driver chip is configured to provide an initial control signal. The voltage regulation unit is configured to provide a driving voltage, wherein the driving voltage is not less than a voltage of the high-level signal in the control signal. The inverting unit includes a second resistor and a second switch, wherein a first terminal of the second resistor is electrically connected to an output terminal of the voltage regulation unit, a second terminal of the second resistor and a first terminal of the second switch are electrically connected to a first node, and a second terminal of the second switch is configured to apply a ground voltage; a control terminal of the second switch is electrically connected to an output terminal of the driver chip; and the second switch is configured to turn on in response to a high-level signal in the initial control signal and to turn off in response to a low-level signal in the initial control signal. The driving unit has a first terminal electrically connected to the output terminal of the voltage regulation unit, a second terminal configured to apply the ground voltage, a control terminal electrically connected to the first node, and an output terminal electrically connected to the control terminal of the power MOSFET; wherein the driving unit is configured to establish conduction between the first terminal of the driving unit and the control terminal of the power MOSFET when a voltage at the first node is low, and to establish conduction between the second terminal of the driving unit and the control terminal of the power MOSFET when the voltage at the first node is high.

According to an embodiment of this disclosure, the driving unit includes a third switch and a fourth switch. A first terminal of the third switch is electrically connected to the output terminal of the voltage regulation unit, a first terminal of the fourth switch is configured to apply the ground voltage, a control terminal of the third switch and a control terminal of the fourth switch are electrically connected to the first node, a second terminal of the third switch and a second terminal of the fourth switch are electrically connected to the control terminal of the power MOSFET. The third switch is configured to turn on when the voltage at the first node is low and to turn off when the voltage at the first node is high; and the fourth switch is configured to turn on when the voltage at the first node is high and to turn off when the voltage on the first node is low.

According to an embodiment of this disclosure, the control module further includes an Electromagnetic Compatibility (EMC) suppression resistor, a terminal of the EMC suppression resistor is electrically connected to the first node, and the other terminal of the EMC suppression resistor is electrically connected to the control terminal of the driving unit.

According to an embodiment of this disclosure, the second switch is a triode or a MOSFET.

According to an embodiment of this disclosure, the control module includes a driver chip, a voltage regulation unit, and a driving unit. The voltage regulation unit is configured to provide a driving voltage, wherein the driving voltage is not less than a voltage of the high-level signal in the control signal. The driver chip is configured to output an initial control signal according to the driving voltage provided by the voltage regulation unit. The driving unit has a first terminal electrically connected to an output terminal of the voltage regulation unit, a second terminal configured to apply a ground voltage, a control terminal configured to receive the initial control signal, and an output terminal electrically connected to the control terminal of the power MOSFET; wherein the driving unit is configured to establish electrical conduction between the first terminal of the driving unit and the power MOSFET in response to a high-level signal in the initial control signal, and to establish electrical conduction between the second terminal of the driving unit and the power MOSFET in response to a low-level signal in the initial control signal.

According to an embodiment of this disclosure, the driving unit includes a third switch and a fourth switch. A first terminal of the third switch is electrically connected to the output terminal of the voltage regulation unit, a first terminal of the fourth switch is configured to apply the ground voltage, a control terminal of the third switch and a control terminal of the fourth switch are configured to receive the initial control signal, a second terminal of the third switch and a second terminal of the fourth switch are electrically connected to the control terminal of the power MOSFET. The third switch is configured to turn on in response to the high-level signal in the initial control signal and to turn off in response to the low-level signal in the initial control signal; and the fourth switch is configured to turn on in response to the low-level signal in the initial control signal and to turn off in response to the high-level signal in the initial control signal.

According to an embodiment of this disclosure, the control module further includes an EMC suppression resistor, a terminal of the EMC suppression resistor is configured to apply the initial control signal, and the other terminal of the EMC suppression resistor is electrically connected to the control terminal of the driving unit.

According to an embodiment of this disclosure, the third switch and the fourth switch are triodes or MOSFETs.

According to an embodiment of this disclosure, the control module includes a driver chip and a voltage regulation unit. The voltage regulation unit is configured to provide a driving voltage, wherein the driving voltage is not less than a voltage of the high-level signal in the control signal. The driver chip is configured to output the control signal according to the driving voltage.

According to an embodiment of this disclosure, the DC-DC boost circuit further includes a gate resistor and a diode, wherein a first terminal of the gate resistor is electrically connected to an output terminal of the control module, and a second terminal of the gate resistor is electrically connected to the control terminal of the power MOSFET; and an anode of the diode is electrically connected to the second terminal of the gate resistor, and a cathode of the diode is electrically connected to the first terminal of the gate resistor.

According to an embodiment of this disclosure, the voltage regulation unit includes a first switch, a voltage regulator diode, a first resistor, and a filter sub-circuit. A first terminal of the first switch is configured to apply an input voltage, a second terminal of the first switch is electrically connected to the output terminal of the voltage regulation unit, and a first resistor is connected between a control terminal of the first switch and the first terminal of the first switch; the control terminal of the first switch is electrically connected to a cathode of the voltage regulator diode, and an anode of the voltage regulator diode is configured to apply the ground voltage; and the filter sub-circuit is electrically connected to the output terminal of the voltage regulation unit.

According to an embodiment of this disclosure, the DC-DC boost circuit further includes an input terminal filter unit, an inductor, a diode, and an output terminal filter unit, wherein a first terminal of the inductor is configured to apply the input voltage and is electrically connected to the input terminal filter unit, a second terminal of the inductor is connected to a first terminal of the power MOSFET, and a second terminal of the power MOSFET is configured to apply the ground voltage; and an anode of the diode is electrically connected to the first terminal of the power MOSFET, and a cathode of the diode is electrically connected to an output terminal of the DC-DC boost circuit and is connected to the output terminal filter unit.

According to another aspect of this disclosure, a driving circuit board is provided, including the DC-DC boost circuit described above.

It should be understood that the above general description and the following detailed description are only exemplary and explanatory and cannot limit the present disclosure.

### BRIEF DESCRIPTION OF THE DRAWINGS

The accompanying drawings herein are incorporated into the specification and form a part of this specification, showing embodiments consistent with this disclosure, and are used together with the specification to explain the principles of this disclosure. Obviously, the drawings in the following description are only some embodiments of this disclosure. For those of ordinary skill in the art, other drawings can be obtained without creative efforts based on these drawings.

FIG. 1 is a schematic structural diagram of a driving circuit board according to an embodiment of this disclosure.

FIG. 2 is a schematic principle diagram of a DC-DC boost circuit according to an embodiment of this disclosure.

FIG. 3 is a schematic principle diagram of a DC-DC boost circuit according to another embodiment of this disclosure.

FIG. 4 is a schematic principle diagram of a control module according to an embodiment of this disclosure.

FIG. 5 is an equivalent circuit diagram of a control module according to an embodiment of this disclosure.

FIG. 6 is an equivalent circuit diagram of a control module according to an embodiment of this disclosure.

FIG. 7 is an equivalent circuit diagram of a control module according to an embodiment of this disclosure.

FIG. 8 is an equivalent circuit diagram of a control module according to an embodiment of this disclosure.

FIG. 9 is a schematic principle diagram of a control module according to an embodiment of this disclosure.

FIG. 10 is an equivalent circuit diagram of a control module according to an embodiment of this disclosure.

FIG. 11 is an equivalent circuit diagram of a control module according to an embodiment of this disclosure.

FIG. 12 is a schematic principle diagram of a control module according to an embodiment of this disclosure.

FIG. 13 is an equivalent circuit diagram of a control module according to an embodiment of this disclosure.

### DETAILED DESCRIPTION

Exemplary embodiments will now be described more fully with reference to the accompanying drawings. However, the exemplary embodiments can be implemented in various forms and should not be construed as being limited to the embodiments set forth herein. On the contrary, these embodiments are provided so that this disclosure will be thorough and complete, and will fully convey the concept of the exemplary embodiments to those skilled in the art. The same reference numerals in the drawings denote the same or similar structures, and thus their detailed descriptions will be omitted. In addition, the drawings are only schematic illustrations of this disclosure and are not necessarily drawn to scale.

The terms “a,” “an,” “the,” “said,” and “at least one” are used to indicate the presence of one or more elements/components/etc. The terms “including/comprising” and “having” are used to indicate an open-ended inclusion and mean that in addition to the listed elements/components/etc., there may also be other elements/components/etc. The terms “first,” “second,” and “third,” etc. are used merely as labels and do not limit the number of their objects.

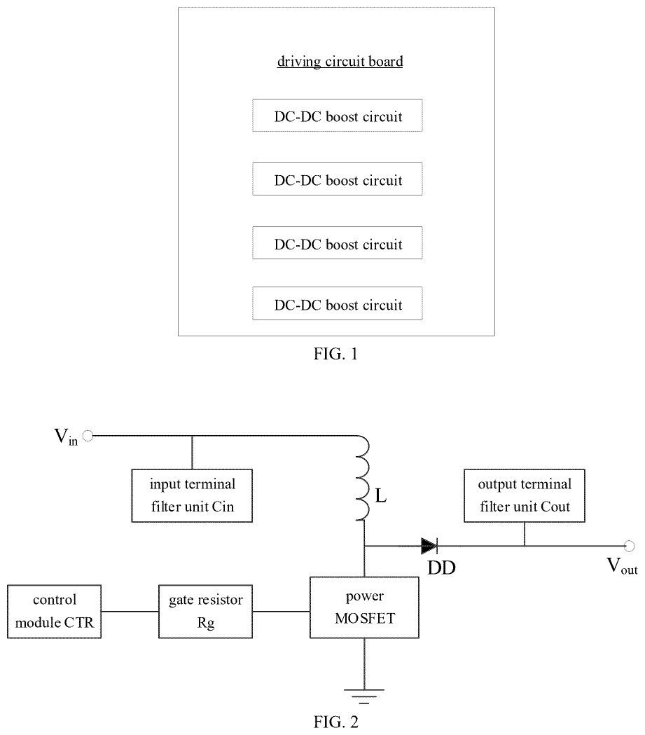

An embodiment of this disclosure provides a driving circuit board. Referring to FIG. 1, one or more DC-DC boost circuits are provided on this driving circuit board. This driving circuit board can be used to drive a lamp panel or a display panel. For example, this driving circuit board can be used to drive a direct-type light-emitting diode (LED) backlight panel or a direct-type Micro LED backlight panel. Of course, the driving circuit board according to the embodiment of this disclosure can also be applied to other devices.

In the driving circuit board provided by this embodiment, the DC-DC boost circuit can be optimized to reduce the power consumption of the power MOSFET in the DC-DC boost circuit, thereby reducing the temperature of the power MOSFET and improving the performance stability of the driving circuit board.

Referring to FIG. 2, this DC-DC boost circuit includes a power MOSFET and a control module CTR connected to a control terminal of the power MOSFET. The control module CTR is configured to provide a control signal capable of controlling the turn-on and turn-off of the power MOSFET. This control signal includes a high-level signal and a low-level signal. A voltage value of the high-level signal in the control signal is 0.5 to 0.8 times the maximum rated value of the gate-source voltage of the power MOSFET.

In this embodiment, the high-level signal of the control signal provided by the control module CTR has a relatively high voltage value. This allows the power MOSFET to maintain a higher gate-source voltage when it turns on, thereby reducing the static loss of the power MOSFET, especially greatly reducing the conduction loss of the power MOSFET. As a result, the power consumption of the power MOSFET is greatly reduced, the heat generation of the power MOSFET is reduced, and the temperature rise of the power MOSFET and the DC-DC boost circuit is prevented from being too high. In this embodiment, when the high-level signal of the control signal is applied to the control terminal of the power MOSFET, the gate-source voltage of the power MOSFET is substantially equal to the voltage value of this high-level signal without considering the voltage drop. Making the voltage value of the high-level signal of the control signal be 0.5 to 0.8 times the maximum rated value of the gate-source voltage of the power MOSFET can not only ensure the safety of the power MOSFET but also increase the gate-source voltage of the power MOSFET when it turns on as much as possible. In this way, this DC-DC boost circuit can reduce the loss and heat generation of the power MOSFET while ensuring the safety of the power MOSFET.

In the related art, the loss of the power MOSFET mainly includes static loss and dynamic loss. The static loss includes conduction loss (also known as electric energy conduction loss) and cutoff loss (also known as turn-off loss). The dynamic loss mainly includes switching loss, gate drive loss, forward loss of the internal diode (also called freewheeling loss), reverse loss of the internal diode, etc. The zero-gate-voltage leakage current of the power MOSFET is relatively small, therefore the cutoff loss is not the main factor contributing to the loss of the power MOSFET. The total gate charge of the power MOSFET and the reverse recovery charge of the PN junction of the internal diode are also very small, therefore the gate drive loss and the reverse loss of the internal diode are not the main factors contributing to the loss of the power MOSFET.

In the related art, the largest portion of the power MOSFET loss lies in the conduction loss. Additionally, the switching loss mainly includes turn-on loss and turn-off loss. In the embodiment of this disclosure, the control module CTR can increase the gate-source voltage of the power MOSFET when it turns on, thereby reducing the static impedance of the power MOSFET when it turns on and reducing the conduction loss of the power MOSFET. At the same time, increasing the gate-source voltage of the power MOSFET when it turns on can also reduce the turn-on loss of the power MOSFET. In this way, the DC-DC boost circuit of the embodiment of this disclosure can reduce the loss of the power MOSFET and the temperature of the power MOSFET.

In one example, the voltage value of the high-level signal in the control signal is 0.6 to 0.7 times the maximum rated value of the gate-source voltage of the power MOSFET. For example, when the maximum rated value of the gate-source voltage of the power MOSFET is 20V, the voltage value of the high-level signal in the control signal can be set to 12˜14V, so that the gate-source voltage of the power MOSFET when it turns on is in the range of 12˜14V.

In some related technologies, a chip can be directly used to control the power MOSFET. The voltage value of the high-level signal of the control signal output by this chip is often relatively low, generally between 4V and 8V. Although this high-level signal is sufficient to make the power MOSFET conduct, due to the insufficient gate-source voltage of the power MOSFET, the power MOSFET has relatively large conduction impedance, resulting in a relatively large conduction loss and serious heat generation of the power MOSFET, and the temperature of the power MOSFET is relatively high. In the embodiment of this disclosure, the gate-source voltage can be increased as much as possible when the power MOSFET is turned on, while ensuring the safety of the power MOSFET. For example, the gate-source voltage can be raised to 12˜14V when the power MOSFET is turned on, thereby achieving the goal of reducing the conduction loss of the power MOSFET, reducing the heat generation of the power MOSFET, and lowering the temperature of the power MOSFET.

It can be understood that the aforementioned embodiment merely serves as an example by illustrating the gate-source voltage of the power MOSFET when it turns on with a maximum rated value of 20V. In other embodiments of this disclosure, the maximum rated value of the gate-source voltage of the power MOSFET may not necessarily be 20V; it could be, for instance, 25V, 30V, or other values. Furthermore, the maximum rated value of the gate-source voltage of the power MOSFET can be obtained by consulting the parameter manual of the power MOSFET.

In an embodiment of this disclosure, the control module CTR is further configured such that when providing a sink current to the control terminal of the power MOSFET, the maximum value of the sink current is not less than 0.5A, for example, between 1A and 2A. In this way, the control module CTR can provide a large sink current to the power MOSFET, further reducing the turn-on loss of the power MOSFET and facilitating the reduction of the temperature of the power MOSFET. It can be understood that when the control module CTR provides a sink current to the control terminal of the power MOSFET, the magnitude of this sink current changes dynamically rather than being a constant current.

In an embodiment of this disclosure, referring to FIG. 2, the DC-DC boost circuit can further include a gate resistor Rg. A first terminal of the gate resistor Rg is electrically connected to an output terminal of the control module CTR, and a second terminal of the gate resistor Rg is electrically connected to the control terminal of the power MOSFET. In this way, when the control module CTR applies a high-level signal to the control terminal of the power MOSFET, the gate resistor Rg can jointly control the sink current to prevent the sink current from being too large instantaneously and damaging the power MOSFET.

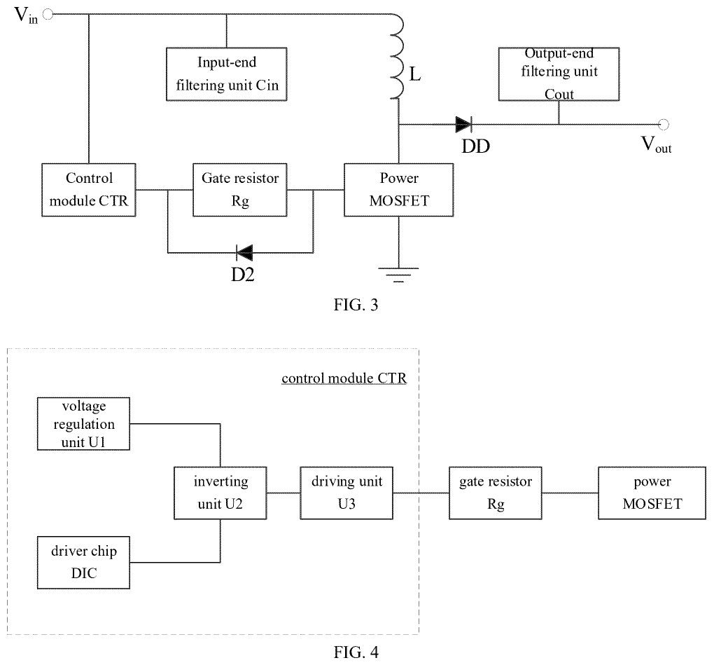

In an embodiment of this disclosure, referring to FIG. 3, the DC-DC boost circuit can further include a diode D2. An anode of the diode D2 is electrically connected to the second terminal of the gate resistor Rg, and a cathode of the diode D2 is electrically connected to the first terminal of the gate resistor Rg. When the control signal output by the control module CTR is a low-level signal, the control terminal of the power MOSFET can discharge through the diode D2 and the gate resistor Rg. At this time, the diode D2 is conducting, enabling the power MOSFET to have a large discharge current, which can reduce the turn-off loss of the power MOSFET.

In an embodiment of this disclosure, referring to FIG. 2, the DC-DC boost circuit further includes an input terminal filter unit Cin, an inductor L, a diode DD, and an output terminal filter unit Cout. A first terminal of the inductor L is used to apply an input voltage Vin and is electrically connected to the input terminal filter unit Cin. A second terminal of the inductor L is electrically connected to a first terminal of the power MOSFET. A second terminal of the power MOSFET is used to apply a ground voltage GND. An anode of the diode DD is electrically connected to the first terminal of the power MOSFET. A cathode of the diode DD is electrically connected to an output terminal of the DC-DC boost circuit and is also connected to the output terminal filter unit Cout. In this way, by controlling the turn-on and turn-off of the power MOSFET, the control module CTR can make an output voltage Vout of the boost circuit higher than the input voltage Vin.

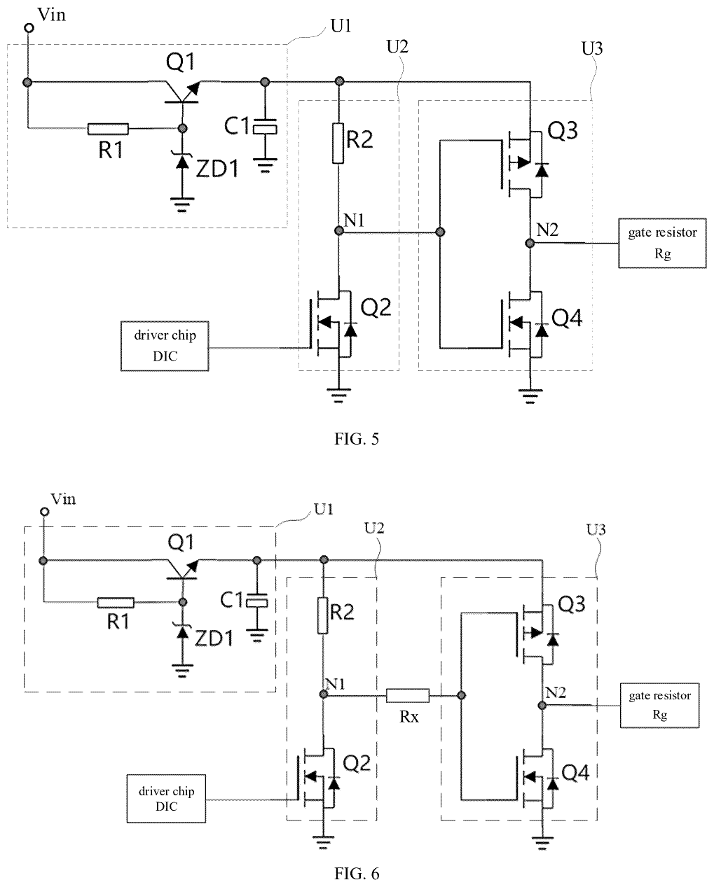

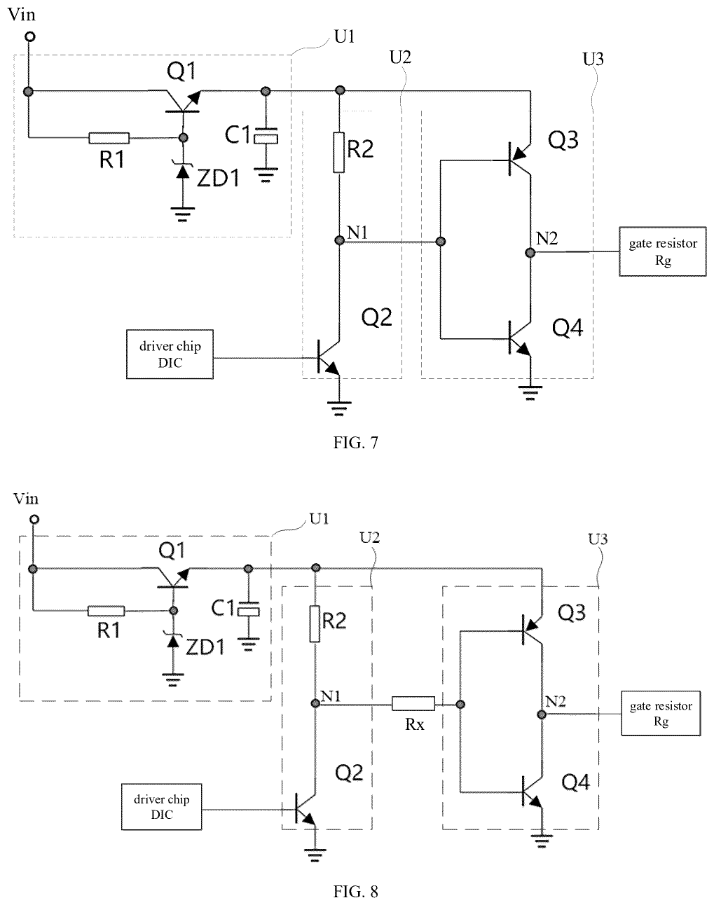

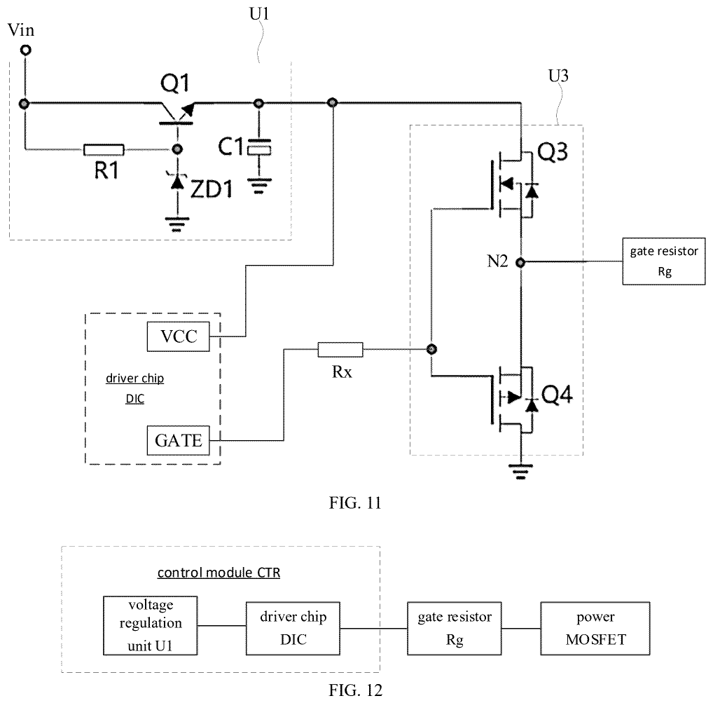

In an embodiment of this disclosure, referring to FIGS. 4 to 13, the control module CTR can include a voltage regulation unit U1. The voltage regulation unit U1 is configured to provide a driving voltage, and the driving voltage is not less than the voltage of the high-level signal in the control signal. The control module CTR can use this driving voltage to make the high-level signal of the output control signal have a relatively high voltage value, achieving the goal of increasing the gate-source voltage of the power MOSFET when it turns on and overcoming the problem that the voltage value of the high-level signal of the control signal directly output by the control chip in the related art is relatively low.

Optionally, the voltage regulation unit U1 can output a driving voltage according to the input voltage Vin. In this way, the power supply on the driving circuit board can supply power to the inductor L and the voltage regulation unit U1 at the same time, which is beneficial for simplifying the circuit of the driving circuit board and reducing the cost of the driving circuit board. Of course, in other embodiments of this disclosure, the voltage regulation unit U1 can also use other power supply voltages to generate the driving voltage.

In one example, the voltage regulation unit U1 includes a first switch Q1, a voltage regulator diode ZD1, a first resistor R1, and a filter sub-circuit C1. A first terminal of the first switch Q1 is used to apply the input voltage Vin, and a second terminal of the first switch Q1 is electrically connected to an output terminal of the voltage regulation unit U1. The first resistor R1 is connected between a control terminal of the first switch Q1 and the first terminal of the first switch Q1. The control terminal of the first switch Q1 is electrically connected to a cathode of the voltage regulator diode ZD1, and an anode of the voltage regulator diode ZD1 is used to apply a ground voltage GND. The filter sub-circuit C1 is electrically connected to the output terminal of the voltage regulation unit U1. In this example, the first switch Q1, the voltage regulator diode ZD1, and the first resistor RI form a voltage regulator, and the filter sub-circuit C1 can filter the output of this voltage regulator to remove the AC component. An appropriate voltage regulator diode ZD1 can be selected according to the required magnitude of the driving voltage. For example, when the maximum rated value of the gate-source voltage of the power MOSFET is 20V and the adopted derating coefficient is 0.6˜0.7, a voltage regulator diode ZD1 with a regulated voltage of 12V˜14V can be selected. It can be understood that when selecting the first switch Q1, the first resistor R1, and the voltage regulator diode ZD1, the specifications (such as current specifications, power specifications, voltage specifications, etc.) of the first switch Q1, the first resistor R1, and the voltage regulator diode ZD1 can also be verified to avoid damage to the first switch Q1, the first resistor R1, and the voltage regulator diode ZD1 during the working process due to insufficient specifications.

In the embodiments of this disclosure, different strategies can be adopted to use the voltage regulation unit U1 to generate the control signal and make the voltage value of the high-level signal of the control signal relatively high, and even make the control module CTR able to provide a large sink current to the control terminal of the power MOSFET.

In an embodiment of this disclosure, referring to FIGS. 4 to 8, the control module CTR includes a driver chip DIC, a voltage regulation unit U1, an inverting unit U2, and a driving unit U3. The driver chip DIC is configured to provide an initial control signal, which includes a high-level signal and a low-level signal. The voltage regulation unit U1 is configured to provide a driving voltage, and the driving voltage is not less than the voltage of the high-level signal in the control signal. The inverting unit U2 includes a second resistor R2 and a second switch Q2. A first terminal of the second resistor R2 is electrically connected to the output terminal of the voltage regulation unit U1. A second terminal of the second resistor R2 and a first terminal of the second switch Q2 are electrically connected to a first node N1. A second terminal of the second switch Q2 is used to apply a ground voltage GND.

The driver chip DIC has an output terminal GATE of a driver chip for outputting the initial control signal. A control terminal of the second switch Q2 is electrically connected to the output terminal of the driver chip. In this way, the control terminal of the second switch Q2 can receive the initial control signal sent by the driver chip DIC. The second switch Q2 is configured to turn on in response to the high-level signal in the initial control signal and to turn off in response to the low-level signal in the initial control signal. When the second switch Q2 turns on, the voltage of the first node N1 is pulled low to the ground voltage GND and becomes a low level. When the second switch Q2 turns off, the voltage of the first node N1 is pulled high by the voltage regulation unit U1 and becomes a high level.

A first terminal of the driving unit U3 is electrically connected to the output terminal of the voltage regulation unit U1. A second terminal of the driving unit U3 is used to apply the ground voltage GND. A control terminal of the driving unit U3 is electrically connected to the first node N1. An output terminal of the driving unit U3 is electrically connected to the control terminal of the power MOSFET. The driving unit U3 is configured to make the first terminal of the driving unit U3 conduct with the control terminal of the power MOSFET when the voltage at the first node N1 is low (at which point the driving unit U3 outputs a high-level signal of the control signal), and make the second terminal of the driving unit U3 conduct with the control terminal of the power MOSFET when the voltage at the first node N1 is high (at which point the driving unit U3 outputs a low-level signal of the control signal).

In this way, when the voltage at the first node N1 is low, the driving voltage can be written into the control terminal of the power MOSFET (i.e., a sink current is provided to charge the control terminal of the power MOSFET) to turn on the power MOSFET, and to make the power MOSFET have a relatively large gate-source voltage when it turns on. Moreover, since the driving voltage has a relatively large voltage value, the driving unit U3 can provide a large sink current to the control terminal of the power MOSFET. Overall, when the initial control signal output by the driver chip DIC is a high-level signal, the control signal output by the driving unit U3 is also a high-level signal. Conversely, when the voltage of the first node N1 is high, the ground voltage GND can be written into the control terminal of the power MOSFET through the driving unit U3 (i.e., a discharge current is provided to make the control terminal of the power MOSFET discharge), thereby making the power MOSFET turn off. In this process, the control terminal of the power MOSFET discharges, which is equivalent to the driving unit U3 providing a discharge current to the control terminal of the power MOSFET. Overall, when the initial control signal output by the driver chip DIC is a low-level signal, the control signal output by the driving unit U3 is also a low-level signal. In this way, the control signal output by the driving unit U3 is synchronized with the initial control signal output by the driver chip DIC.

In this embodiment, the inverting unit U2 and the driving unit U3 together form a level conversion sub-circuit, which converts the high-level voltage of the initial control signal output by the driver chip DIC into the gate driving voltage required by the power MOSFET. The driving unit U1 provides the sink current in the gate driving current required by the power MOSFET. This gate driving current also includes a discharge current (also known as a leakage current).

Optionally, the voltage value of the high-level signal output by the driving unit U3 is greater than the voltage value of the high-level signal of the initial control signal output by the driver chip DIC. In this way, this control module CTR can convert the high-level signal with a low voltage value output by the driver chip DIC into a high-level signal with a high voltage value, thereby increasing the gate-source voltage of the power MOSFET when conducting and reducing the loss of the power MOSFET.

Optionally, the sink current output by the driving unit U3 is greater than the sink current output by the driver chip DIC to further reduce the turn-on loss of the power MOSFET.

In some examples of this embodiment, the second switch Q2 can be a MOSFET, for example, an N-type MOSFET. In this way, the second switch Q2 has a relatively wide range of applications, especially in high-power DC-DC boost circuits. For example, when the power of the DC-DC boost circuit is greater than 100W, for example, when the power of the DC-DC boost circuit is 150W, the second switch Q2 can be a MOSFET.

In other examples of this embodiment, the second switch Q2 can be a triode. In this way, the second switch Q2 can be applied in medium to low-power DC-DC boost circuits. For example, when the power of the DC-DC boost circuit is not greater than 100W, such as 80W, the second switch Q2 can be a triode.

In some examples of this embodiment, the driving unit U3 includes a third switch Q3 and a fourth switch Q4. A first terminal of the third switch Q3 is connected to the output terminal of the voltage regulation unit U1. A first terminal of the fourth switch Q4 is used to apply a ground voltage GND. A control terminal of the third switch Q3 and a control terminal of the fourth switch Q4 are electrically connected to the first node N1. A second terminal of the third switch Q3 and a second terminal of the fourth switch Q4 are electrically connected to a second node N2, and the second node N2 is electrically connected to the control terminal of the power MOSFET. For example, the second node N2 is electrically connected to the control terminal of the power MOSFET through the gate resistor Rg. The third switch Q3 is configured to turn on when the voltage at the first node N1 is low and to turn off when the voltage at the first node N1 is high. The fourth switch Q4 is configured to turn on when the voltage at the first node N1 is high and to turn off when the voltage at the first node N1 is low.

In one example, the third switch Q3 and the fourth switch Q4 can be MOSFETs. For example, the third switch Q3 can be a P-type MOSFET and the fourth switch Q4 can be an N-type MOSFET. This driving unit U3 has a relatively wide range of applications, especially in high-power DC-DC boost circuits. For example, when the power of the DC-DC boost circuit is greater than 100W, such as 150W, the third switch Q3 and the fourth switch Q4 can be MOSFETs.

In another example, the third switch Q3 and the fourth switch Q4 can be triodes. In this case, this driving unit U3 can be applied in medium to low-power DC-DC boost circuits. For example, when the power of the DC-DC boost circuit is not greater than 100W, such as 80W, the third switch Q3 and the fourth switch Q4 can be triodes.

In one example, the second switch Q2, the third switch Q3, and the fourth switch Q4 are MOSFETs. The embodiment of this disclosure also verifies the DC-DC boost circuit. Three DC-DC boost circuits are provided on a verification driving circuit board, and these DC-DC boost circuits all use the control module of this disclosure to control the power MOSFETs. Other three DC-DC boost circuits are provided on a comparison driving circuit board. The three DC-DC boost circuits on the verification driving circuit board correspond one-to-one with the other three DC-DC boost circuits on the comparison driving circuit board. The three DC-DC boost circuits on the comparison driving circuit board use conventional technology, namely, directly controlling the power MOSFETs with driver chips. The driver chips on the verification driving circuit board are the same as the driver chips on the comparison driving circuit board. The verification driving circuit board and the comparison driving circuit board are both operated for 2.5 hours before measuring the temperatures of the power MOSFET in each DC-DC boost circuit. The temperatures of the three power MOSFETs on the verification driving circuit board are 80.0° C., 83.5° C., and 67.2° C., respectively; while the temperatures of the corresponding three power MOSFETs on the comparison driving circuit board are 96.0° C., 92.8° C., and 89.8° C., respectively. It can be seen that after adopting the solution of this embodiment, the temperatures of the three power MOSFETs on the driving circuit board have all dropped significantly (the first power MOSFET drops from 96.0° C. to 80.0° C., the second power MOSFET drops from 92.8° C. to 83.5° C., and the third power MOSFET drops from 89.8° C. to 67.2° C.).

In another example, the second switch Q2, the third switch Q3, and the fourth switch Q4 are triodes.

In one example, the on-resistance of both the third switch Q3 and the fourth switch Q4 is relatively small, for example, both are less than 2 ohms.

In an embodiment of this disclosure, a second resistor R2 with an appropriate resistance value can be selected so that the current passing through the second resistor R2 when it conducts is between 50 mA and 300 mA. In this way, the steepness of the waveform of the first node N1 can be improved.

In one example of this embodiment, the control module CTR further includes an Electromagnetic Compatibility (EMC) suppression resistor Rx. A first terminal of the EMC suppression resistor Rx is electrically connected to the first node N1, and a second terminal of the EMC suppression resistor Rx is electrically connected to the control terminal of the driving unit U3 (for example, electrically connected to the control terminals of the third switch Q3 and the fourth switch Q4). The electromagnetic interference can be reduced by reasonably setting the resistance value of the EMC suppression resistor Rx.

In this embodiment, the driving voltage provided by the voltage regulation unit U1 does not need to be applied to the driver chip DIC, and the sink current finally output by the control module CTR is provided by the voltage regulation unit U1 instead of the driver chip DIC. Therefore, this embodiment can be applied to various types of driver chips DIC as long as the driver chip DIC can provide an initial control signal. For example, the driver chip DIC can be a chip that can use an external supply voltage or a chip that cannot use an external supply voltage, which can greatly expand the selection range of the driver chip DIC, avoid the situation where the selection range is too small, resulting in high material costs and low chip versatility, and is thus beneficial for reducing costs. For example, when the driver chip DIC is a chip that cannot use an external supply voltage, the voltage value of the high-level signal of the initial control signal output by this driver chip DIC is determined by the internal voltage of the chip, is a fixed voltage and is generally relatively low, and the output sink current is generally relatively small. The embodiments of this disclosure can use this initial control signal to control the second switch Q2, and then control the driving unit U3. By means of the driving voltage provided by the driving unit U3 and the voltage regulation unit U1, the high-level signal of the control signal and the sink current are generated.

Another example is that when the driver chip DIC is a chip that can use an external supply voltage, an external supply voltage can also not be set for this driver chip DIC. In this way, the voltage value of the high-level signal of the initial control signal output by this driver chip DIC is determined by the internal voltage of the chip, is a fixed voltage and is generally relatively low, and the output sink current is generally relatively small. The embodiments of this disclosure can use this initial control signal to control the second switch Q2, and then control the driving unit U3. By means of the driving voltage provided by the driving unit U3 and the voltage regulation unit U1, the high-level signal of the control signal and the sink current are generated.

In other embodiments of this disclosure, the driver chip DIC is a chip that can use an external supply voltage. In this case, the driver chip DIC can use the driving voltage provided by the voltage regulation unit U1 to make the high-level signal of the output initial control signal have a relatively large voltage value. In the prior art, control chips that can output a high-level signal often have high costs, and there are relatively few types and specifications. Directly using these control chips to configure the DC-DC boost circuit will significantly increase the cost of the DC-DC boost circuit and reduce the flexibility in configuring the DC-DC boost circuit. In this embodiment, the driving voltage provided by the voltage regulation unit U1 can be applied to the driver chip DIC as an external supply voltage of the driver chip DIC. The driver chip DIC outputs the high-level signal of the initial control signal according to this driving voltage, which can greatly improve the flexibility in selecting the control chip and reduce the cost.

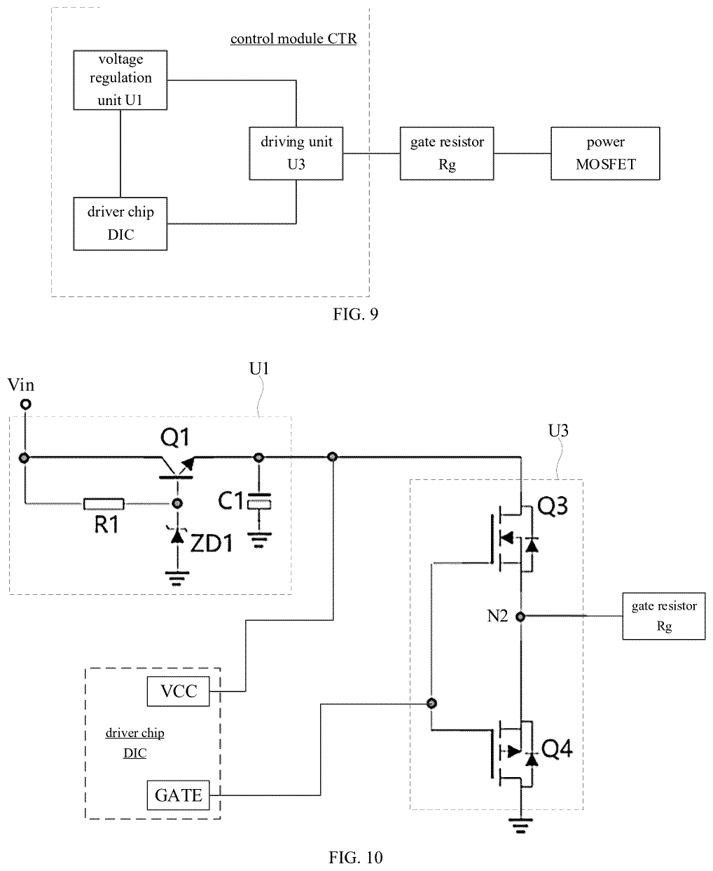

In an embodiment of this disclosure, referring to FIGS. 9 to 11, the control module CTR includes a driver chip DIC, a voltage regulation unit U1, and a driving unit U3. The voltage regulation unit U1 is configured to provide a driving voltage, and the driving voltage is not less than the voltage of the high-level signal in the control signal. The driver chip DIC is a control chip that can use an external supply voltage and is configured to output an initial control signal according to the driving voltage provided by the voltage regulation unit U1. A first terminal of the driving unit U3 is electrically connected to an output terminal of the voltage regulation unit U1. A second terminal of the driving unit U3 is used to apply a ground voltage GND. A control terminal of the driving unit U3 is configured to receive the initial control signal. An output terminal of the driving unit U3 is electrically connected to a gate of the power MOSFET. The driving unit U3 is configured to make the first terminal of the driving unit U3 electrically conduct with the power MOSFET in response to the high-level signal in the initial control signal, and to make the second terminal of the driving unit U3 electrically conduct with the power MOSFET in response to the low-level signal in the initial control signal.

In this embodiment, the high-level signal of the initial control signal output by the driver chip DIC has a sufficiently high voltage value, so it is sufficient to directly drive the driving unit U3. Therefore, the control module CTR of this embodiment does not need to be provided with an inverting unit U2, which can reduce the cost of the control module CTR.

In one example of this embodiment, the driving unit U3 includes a third switch Q3 and a fourth switch Q4. A first terminal of the third switch Q3 is electrically connected to the output terminal of the voltage regulation unit U1. A first terminal of the fourth switch Q4 is used to apply the ground voltage GND. A control terminal of the third switch Q3 and a control terminal of the fourth switch Q4 are configured to receive the initial control signal. A second terminal of the third switch Q3 and a second terminal of the fourth switch Q4 are electrically connected to a second node N2, and the second node N2 is electrically connected to the control terminal of the power MOSFET. For example, the second node N2 is electrically connected to the control terminal of the power MOSFET through a gate resistor Rg. The third switch Q3 is configured to turn on in response to the high-level signal in the initial control signal and to turn off in response to the low-level signal in the initial control signal. The fourth switch Q4 is configured to turn on in response to the low-level signal in the initial control signal and to turn off in response to the high-level signal in the initial control signal.

Optionally, the third switch Q3 can be an N-type MOSFET and the fourth switch Q4 can be a P-type MOSFET. In this way, this driving unit U3 has greater applicability, for example, it can also be applied under high power. For example, in a DC-DC boost circuit with a power greater than 100W, the third switch Q3 and the fourth switch Q4 in the driving unit U3 can be MOSFETs. In other examples of this disclosure, the third switch Q3 and the fourth switch Q4 can also be triodes of opposite types. In this case, this driving unit U3 can be applied to medium to low-power DC-DC boost circuits. For example, in a DC-DC boost circuit with a power not greater than 100W, the third switch Q3 and the fourth switch Q4 in the driving unit U3 can be triodes.

In one example of this embodiment, the control module CTR further includes an EMC suppression resistor Rx. A first terminal of the EMC suppression resistor Rx is electrically connected to the output terminal of the driver chip, and a second terminal of the EMC suppression resistor Rx is electrically connected to the control terminal of the driving unit U3 (for example, electrically connected to the control terminals of the third switch Q3 and the fourth switch Q4). The electromagnetic interference can be reduced by reasonably setting the resistance value of the EMC suppression resistor Rx.

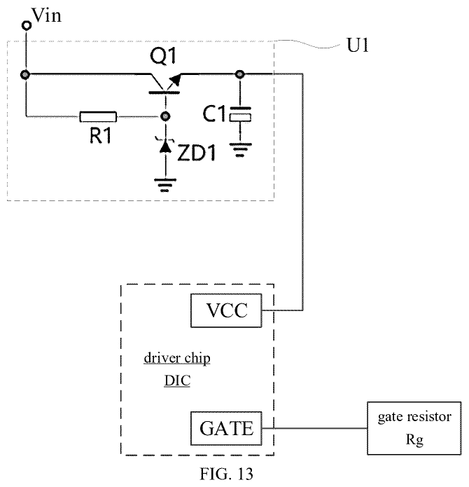

In another embodiment of this disclosure, referring to FIGS. 12 and 13, the control module CTR includes a driver chip DIC and a voltage regulation unit U1. The voltage regulation unit U1 is configured to provide a driving voltage, and the driving voltage is not less than the voltage of the high-level signal in the control signal. The driver chip DIC is a control chip that can use an external supply voltage and is configured to output the control signal according to the driving voltage. In this embodiment, the initial control signal output by the driver chip DIC can be used as the control signal and directly applied to the control terminal of the power MOSFET without the need to adjust the voltage or current through the driving unit U3.

Exemplarily, referring to FIG. 13, the driver chip DIC has an external supply voltage terminal VCC for applying an external supply voltage and an output terminal GATE for outputting the control signal. The output terminal of the voltage regulation unit U1 can be electrically connected to the external supply voltage terminal VCC, so that the driving voltage is applied to the driver chip DIC as an external supply voltage. The driver chip DIC can output the control signal from the output terminal GATE according to this external supply voltage instead of outputting the control signal according to the internal constant voltage. This makes the high-level signal of this control signal have a high voltage value. The output terminal GATE can be electrically connected to the control terminal of the power MOSFET. For example, the output terminal GATE can be electrically connected to the control terminal of the power MOSFET through a gate resistor Rg.

In this embodiment, the driver chip DIC can generate the control signal according to the external supply voltage (driving voltage) provided by the voltage regulation unit U1. The high-level signal of this control signal has a relatively high voltage value, thus significantly reducing the conduction loss at the control terminal of the power MOSFET. Especially when the control requirement for temperature rise of the DC-DC boost circuit is not very strict, the control module CTR of this embodiment can omit the inverting unit U2 and the driving unit U3, thereby reducing the cost of the control module CTR.

Those skilled in the art, after considering the specification and practicing the invention disclosed herein, will readily conceive of other embodiments of this disclosure. This application is intended to cover any variations, uses, or adaptations of this disclosure, which follow the general principles of this disclosure and include common knowledge or customary technical means in the technical field of this disclosure that are not disclosed herein. The specification and embodiments are only regarded as exemplary.

1. A Direct Current to Direct Current (DC-DC) boost circuit, comprising:
a power Metal-Oxide-Semiconductor Field-Effect Transistor (MOSFET); and
a control circuit electrically connected to a control terminal of the power MOSFET and configured to provide a control signal capable of controlling turn-on and turn-off of the power MOSFET;
wherein a voltage value of a high-level signal in the control signal is 0.5 to 0.8 times a maximum rated value of a gate-source voltage of the power MOSFET.

2. The DC-DC boost circuit according to claim 1, wherein the control circuit is further configured such that when providing a sink current to the control terminal of the power MOSFET, a maximum value of the sink current is not less than 0.5A.

3. The DC-DC boost circuit according to claim 1, wherein the control circuit comprises:
a driver chip configured to provide an initial control signal;
a voltage regulation circuit configured to provide a driving voltage, wherein the driving voltage is not less than a voltage of the high-level signal in the control signal;
an inverting circuit comprising a second resistor and a second switch, wherein a first terminal of the second resistor is electrically connected to an output terminal of the voltage regulation circuit, a second terminal of the second resistor and a first terminal of the second switch are electrically connected to a first node, and a second terminal of the second switch is configured to apply a ground voltage; a control terminal of the second switch is electrically connected to an output terminal of the driver chip; and the second switch is configured to turn on in response to a high-level signal in the initial control signal and to turn off in response to a low-level signal in the initial control signal; and
a driving circuit having a first terminal electrically connected to the output terminal of the voltage regulation circuit, a second terminal configured to apply the ground voltage, a control terminal electrically connected to the first node, and an output terminal electrically connected to the control terminal of the power MOSFET; wherein the driving circuit is configured to establish conduction between the first terminal of the driving circuit and the control terminal of the power MOSFET when a voltage at the first node is low, and to establish conduction between the second terminal of the driving circuit and the control terminal of the power MOSFET when the voltage at the first node is high.

4. The DC-DC boost circuit according to claim 3, wherein the driving circuit comprises a third switch and a fourth switch;
wherein a first terminal of the third switch is electrically connected to the output terminal of the voltage regulation circuit, a first terminal of the fourth switch is configured to apply the ground voltage, a control terminal of the third switch and a control terminal of the fourth switch are electrically connected to the first node, a second terminal of the third switch and a second terminal of the fourth switch are electrically connected to the control terminal of the power MOSFET; and
wherein the third switch is configured to turn on when the voltage at the first node is low and to turn off when the voltage at the first node is high; and the fourth switch is configured to turn on when the voltage at the first node is high and to turn off when the voltage on the first node is low.

5. The DC-DC boost circuit according to claim 3, wherein the control circuit further comprises an Electromagnetic Compatibility (EMC) suppression resistor, a terminal of the EMC suppression resistor is electrically connected to the first node, and the other terminal of the EMC suppression resistor is electrically connected to the control terminal of the driving circuit.

6. The DC-DC boost circuit according to claim 3, wherein the second switch is a triode or a MOSFET.

7. The DC-DC boost circuit according to claim 1, wherein the control circuit comprises:
a voltage regulation circuit configured to provide a driving voltage, wherein the driving voltage is not less than a voltage of the high-level signal in the control signal;
a driver chip configured to output an initial control signal according to the driving voltage provided by the voltage regulation circuit;
a driving circuit having a first terminal electrically connected to an output terminal of the voltage regulation circuit, a second terminal configured to apply a ground voltage, a control terminal configured to receive the initial control signal, and an output terminal electrically connected to the control terminal of the power MOSFET; wherein the driving circuit is configured to establish electrical conduction between the first terminal of the driving circuit and the power MOSFET in response to a high-level signal in the initial control signal, and to establish electrical conduction between the second terminal of the driving circuit and the power MOSFET in response to a low-level signal in the initial control signal.

8. The DC-DC boost circuit according to claim 7, wherein the driving circuit comprises a third switch and a fourth switch;
wherein a first terminal of the third switch is electrically connected to the output terminal of the voltage regulation circuit, a first terminal of the fourth switch is configured to apply the ground voltage, a control terminal of the third switch and a control terminal of the fourth switch are configured to receive the initial control signal, a second terminal of the third switch and a second terminal of the fourth switch are electrically connected to the control terminal of the power MOSFET; and
wherein the third switch is configured to turn on in response to the high-level signal in the initial control signal and to turn off in response to the low-level signal in the initial control signal; and
the fourth switch is configured to turn on in response to the low-level signal in the initial control signal and to turn off in response to the high-level signal in the initial control signal.

9. The DC-DC boost circuit according to claim 7, wherein the control circuit further comprises an Electromagnetic Compatibility (EMC) suppression resistor, a terminal of the EMC suppression resistor is configured to apply the initial control signal, and the other terminal of the EMC suppression resistor is electrically connected to the control terminal of the driving circuit.

10. The DC-DC boost circuit according to claim 4, wherein the third switch and the fourth switch are triodes or MOSFETs.

11. The DC-DC boost circuit according to claim 1, wherein the control circuit comprises:
a voltage regulation circuit configured to provide a driving voltage, wherein the driving voltage is not less than a voltage of the high-level signal in the control signal; and
a driver chip configured to output the control signal according to the driving voltage.

12. The DC-DC boost circuit according to claim 1, further comprising a gate resistor and a diode;
wherein a first terminal of the gate resistor is electrically connected to an output terminal of the control circuit, and a second terminal of the gate resistor is electrically connected to the control terminal of the power MOSFET; and an anode of the diode is electrically connected to the second terminal of the gate resistor, and a cathode of the diode is electrically connected to the first terminal of the gate resistor.

13. The DC-DC boost circuit according to claim 3, wherein the voltage regulation circuit comprises a first switch, a voltage regulator diode, a first resistor, and a filter sub-circuit;
a first terminal of the first switch is configured to apply an input voltage, a second terminal of the first switch is electrically connected to the output terminal of the voltage regulation circuit, and a first resistor is connected between a control terminal of the first switch and the first terminal of the first switch; the control terminal of the first switch is electrically connected to a cathode of the voltage regulator diode, and an anode of the voltage regulator diode is configured to apply the ground voltage; and the filter sub-circuit is electrically connected to the output terminal of the voltage regulation circuit.

14. The DC-DC boost circuit according to claim 13, further comprising an input terminal filter circuit, an inductor, a diode, and an output terminal filter circuit;
wherein a first terminal of the inductor is configured to apply the input voltage and is electrically connected to the input terminal filter circuit, a second terminal of the inductor is connected to a first terminal of the power MOSFET, and a second terminal of the power MOSFET is configured to apply the ground voltage; and
an anode of the diode is electrically connected to the first terminal of the power MOSFET, and a cathode of the diode is electrically connected to an output terminal of the DC-DC boost circuit and is connected to the output terminal filter circuit.

15. A driving circuit board, comprising a DC-DC boost circuit, wherein the DC-DC boost circuit comprises:
a power Metal-Oxide-Semiconductor Field-Effect Transistor (MOSFET); and
a control circuit electrically connected to a control terminal of the power MOSFET and configured to provide a control signal capable of controlling turn-on and turn-off of the power MOSFET:
wherein a voltage value of a high-level signal in the control signal is 0.5 to 0.8 times a maximum rated value of a gate-source voltage of the power MOSFET.

16. The driving circuit board according to claim 15, wherein the control circuit comprises:
a driver chip configured to provide an initial control signal;
a voltage regulation circuit configured to provide a driving voltage, wherein the driving voltage is not less than a voltage of the high-level signal in the control signal;
an inverting circuit comprising a second resistor and a second switch, wherein a first terminal of the second resistor is electrically connected to an output terminal of the voltage regulation circuit, a second terminal of the second resistor and a first terminal of the second switch are electrically connected to a first node, and a second terminal of the second switch is configured to apply a ground voltage; a control terminal of the second switch is electrically connected to an output terminal of the driver chip; and the second switch is configured to turn on in response to a high-level signal in the initial control signal and to turn off in response to a low-level signal in the initial control signal; and
a driving circuit having a first terminal electrically connected to the output terminal of the voltage regulation circuit, a second terminal configured to apply the ground voltage, a control terminal electrically connected to the first node, and an output terminal electrically connected to the control terminal of the power MOSFET; wherein the driving circuit is configured to establish conduction between the first terminal of the driving circuit and the control terminal of the power MOSFET when a voltage at the first node is low, and to establish conduction between the second terminal of the driving circuit and the control terminal of the power MOSFET when the voltage at the first node is high.

17. The driving circuit board according to claim 16, wherein the driving circuit comprises a third switch and a fourth switch;
wherein a first terminal of the third switch is electrically connected to the output terminal of the voltage regulation circuit, a first terminal of the fourth switch is configured to apply the ground voltage, a control terminal of the third switch and a control terminal of the fourth switch are electrically connected to the first node, a second terminal of the third switch and a second terminal of the fourth switch are electrically connected to the control terminal of the power MOSFET; and
wherein the third switch is configured to turn on when the voltage at the first node is low and to turn off when the voltage at the first node is high; and the fourth switch is configured to turn on when the voltage at the first node is high and to turn off when the voltage on the first node is low.

18. The driving circuit board according to claim 15, wherein the control circuit comprises:
a voltage regulation circuit configured to provide a driving voltage, wherein the driving voltage is not less than a voltage of the high-level signal in the control signal;
a driver chip configured to output an initial control signal according to the driving voltage provided by the voltage regulation circuit;
a driving circuit having a first terminal electrically connected to an output terminal of the voltage regulation circuit, a second terminal configured to apply a ground voltage, a control terminal configured to receive the initial control signal, and an output terminal electrically connected to the control terminal of the power MOSFET; wherein the driving circuit is configured to establish electrical conduction between the first terminal of the driving circuit and the power MOSFET in response to a high-level signal in the initial control signal, and to establish electrical conduction between the second terminal of the driving circuit and the power MOSFET in response to a low-level signal in the initial control signal.

19. The driving circuit board according to claim 18, the driving circuit comprises a third switch and a fourth switch;
wherein a first terminal of the third switch is electrically connected to the output terminal of the voltage regulation circuit, a first terminal of the fourth switch is configured to apply the ground voltage, a control terminal of the third switch and a control terminal of the fourth switch are configured to receive the initial control signal, a second terminal of the third switch and a second terminal of the fourth switch are electrically connected to the control terminal of the power MOSFET; and
wherein the third switch is configured to turn on in response to the high-level signal in the initial control signal and to turn off in response to the low-level signal in the initial control signal; and
the fourth switch is configured to turn on in response to the low-level signal in the initial control signal and to turn off in response to the high-level signal in the initial control signal.

20. The driving circuit board according to claim 15, wherein the control circuit comprises:
a voltage regulation circuit configured to provide a driving voltage, wherein the driving voltage is not less than a voltage of the high-level signal in the control signal; and
a driver chip configured to output the control signal according to the driving voltage.
